(19) United States
(12) Patent Application Publication
(10) Pub. No.: US 2010/0001815 A1
(43) Pub. Date: Jan. 7, 2010

(54) FILTER FOR ELECTRONIC SIGNALS AND METHOD FOR MANUFACTURING IT

(75) Inventors: Murat Emre ERMUTLU, Helsinki (FI); Jorma Tapio PALLONEN, Kirkkonummi (FI)

Correspondence Address: STAAS & HALSEY LLP, SUITE 700, 1201 NEW YORK AVENUE, N.W., WASHINGTON, DC, 20005, US

(73) Assignee: Nokia Siemens Networks, Oy of Espoo (FI)

(21) Appl. No.: 12/498,894

(22) Filed: Jul. 7, 2009

(30) Foreign Application Priority Data
Jul. 7, 2008 (EP) EP08104660

(51) Int. Cl. H01P 1/20; H01S 4/00

(52) U.S. Cl. 333/206; 29/592.1

(57) ABSTRACT

A dielectric body is provided with at least two coupling structures for coupling in and coupling out electronic signals, and one or more conductors on surface portions of the body. An outer surface of the body includes one or more indentations. The coupling structure includes a coupling conductor for signal input and/or output, and in relation to an end portion of the conductor a coupling hole extending from the first surface and/or from a second surface opposite the first surface into the body.

### CROSS REFERENCE TO RELATED APPLICATIONS

This application is based on and hereby claims priority to European Application No. 08104660 filed on Jul. 7, 2008, the contents of which are hereby incorporated by reference.

### BACKGROUND

Described below is a filter for electronic signals and to a method for manufacturing it. The filters under consideration may be filters having a ceramic body with appropriate metallizations thereon such as ceramic monoblock filters.

Ceramic single mode monoblock filters are used in small and medium power base transmitting site (BTS) products for the reason of size and cost. Also the electrical performance is satisfactory, especially if the dimensions of the filter body are increased. This causes that the rectangular filter body starts passing through electromagnetic energy at higher resonance modes and begins to leak through power beyond a certain cut off frequency. The smaller the body is the higher the cut off frequency is. It is roughly relative to equation: 1/((εr)½×W×L). This leakage is caused by non-desired higher propagation modes in the ceramic material. That is similar to the propagation in a waveguide that is bigger than required to allow just the lowest order mode. The leaking energy is at the harmonics of the desired operating frequency. This would be tolerable if the second and third harmonic at least could be reduced sufficiently.

FIGS. 1A to 1E illustrate known ceramic monoblock filters 1 which has a ceramic body 10 with a carefully designed shape and metallizations thereon and with a selected dielectric constant. The filter 1 may have coupling structures 19 for signal input and output, respectively. These coupling structures include conductors on a first surface 11 of the filter body. These conductors 19 may be coupled to external wiring, such as wiring on a printed circuit board (PCB). From the first surface 11 of the body 10 holes may be extending into the body and often through the body down to the opposing surface 12.

Surfaces of the body 10 including the inner surfaces of holes 17 may have a more or less continuous metallization thereon. It is to be noted that on one or more particular surfaces this more or less continuous metallization may not or only partially be provided, such as the first surface 11. Reference numeral 18 indicates conductors which may be metallizations and which are shown in FIG. 1A as continuous conductive layers covering all surfaces of the body except the first surface 11. The conductor 18 also covers the inner walls of the hole 17 and may be grounded in use.

The holes 17 act as resonators. They have circular or elliptic cross-section. 101 and 102 define symmetry axes of the filter 1. 101 is a longitudinal axis defined by the mid-points of two holes 17 provided in the ceramic monoblock filter 1. It coincides with the symmetry axis of the body 10 itself in that it is the centerline between surfaces 13 and 14, so that the holes 1 8 are arranged symmetrically in block 10. The holes 17 extend perpendicularly with respect to the first surface 11. 102 is another symmetry axis. The two holes 17 are symmetrically positioned with respect to this axis 102 which is also the centerline between surfaces 15 and 16.

The body 10 and the overall filter 1 is a cuboid with three pairs of opposing surfaces (11 and 12, 13 and 14, 15 and 16), the surfaces being substantially flat/plane and rectangular to each other. The body 10 is formed of a ceramic material with a certain relative dielectric constant, which is again selected in view of electronic properties. Holes 17 together with their cladding 18 and the surrounding body 10 and its outside conductors 18 of the filter 1 serve as resonators, the resonating frequencies being adjusted by defining the geometrical dimensions of the body, by forming the coupling conductors 19 and appropriately selecting the dielectric constant εᵣ. The thickness is the predominant parameter for defining the resonating frequency. The filter has a length L, a width W, and a height H. The holes extend in height direction.

FIG. 1B shows a vertical cross-section of the filter 1. It shows the through-holes 17 extending from the first surface 11 to the second surface 12, and it shows all recognizable body surfaces except the first surface 11 coated by a conductor 18. In use, the conductor 18 may be grounded. The first surface 11 may carry coupling conductors 19 of appropriate shape, size and arrangement. It may also carry conductors connected to the conductors of the other surfaces. The conductors of the other surfaces 12 to 16 are continuously connected to each other along the respective common edges.

FIG. 1C shows a ceramic monoblock filter 1 on a printed circuit board (PCB) 103. The holes 17 extend in a direction more or less parallel to the surface of the PCB 103. The surface conductors 18 are connected to conductors on PCB 103. Particularly, they may be grounded. The first surface 11 pointing upwards in FIG. 1A points now towards the viewer of FIG. 1C. The coupling connectors 19 are connected to wiring 105 on the PCB and may, through this wiring, be connected to other electronic components 104 and/or to a connector 106.

The field of use of such ceramic monoblock filters is wireless communication. They are used both in mobile stations and in base stations. In mobile stations, size and cost are very relevant criteria. In base stations, quality and costs are relevant criteria. The holes 17 together with the coupling conductors 19 and the metallizations/conductors 18 serve as resonators, and through the resonating effect they provide filtering as desired. The design is such that desired propagation modes of electric fields and magnetic fields are supported as far as possible, whereas undesired propagation modes and frequencies and harmonics are suppressed as far as possible.

The manufacturing method is that first a cuboid as desired is pressed from powder of the material that is to form the body 10. After pressing, the body has a consistency similar to sugar cubes, i.e. it withstands some mechanical impact, but is destroyable. After pressing, the body is fired under a certain temperature profile over time. It may be exposed to temperatures higher than 1000 or 1500° C. for several hours. Through this firing, the powder particles do not melt, but are sintered together. After firing, the body is machined to the desired final external shape and the desired holes are drilled into the body 10, and thereafter the body is immersed into a bath of silver paint, what may be repeated several times. After drying, the paint-covered body is again fired for increasing conductivity of the conductor cladding on the walls. Finally, the conductors on the top surface (first surface 11) may be structured as required for the tuning of the filtering performance.

The disadvantage of the present ceramic monoblock filters is that, at a given dimensioning and external circuitry requirement, they show insufficient suppression of certain modes and frequencies, particularly, harmonics are insufficiently suppressed. For the reason that touching the filter dimensions leads to reduced performance, alternative methods, like additional filtering on the PCB 103 must be used. This is sufficiently good but causes additional loss and consumes PCB space. A receiver is protected by using higher power low noise amplifiers (LNA) and an additional small filter behind it. This consumes space and adds to costs. This is not so critical in big units but is getting increasingly important when the units get smaller like in medium range and active antenna products.

Another disadvantage of prior art circuitry is insufficient or undesired coupling of incoming and outgoing signals. The present coupling is made in voltage made or in current mode using one of the resonator rods as a coupling element. In voltage mode, the coupling conductor approaches a resonator hole 17, but is not in electrical contact with the conductor on the inner wall of the hole, whereas in current mode coupling the coupling conductor is in electrical contact with the conductor on the inner wall of the resonator hole.

FIGS. 1D and 1E show such structures schematically. FIG. 1D shows voltage mode coupling. A coupling conductor 19a runs from the rim of the first surface 11 towards the hole 17 and may surround it fully or partially, without, however, contacting the conductor 18 on the inner wall of hole 17. The rim end 191 of coupling conductor 190 is for rendering connections to external circuitry, whereas the resonator end portion 192 provides coupling with resonator hole 17. In voltage mode coupling as shown in FIG. 1 D, an electromagnetic coupling is provided between coupling conductor part 192 and conductor 18 on the inside of the resonator hole 17. The coupling mechanism goes predominantly via the electric field having effect on the conductor 18 on the inside of the hole.

FIG. 1E shows current mode coupling in which the rim end 191 of the coupling conductor 190 runs towards the resonator hole 17 and, there, contacts the conductor 18 on the inside of hole 17. A conductive rim 192 may surround the hole 17, where it contacts the conductor 18 on the inside wall of resonator hole 17. For DC, this may constitute a short circuit to the potentially grounded metallization 18, but for HF it is a suitable direct coupling.

The disadvantage of known couplings is that they are not optimized either in the sense of matching or in the sense of coupling efficiency or mode/frequency selectivity. The current mode coupling (FIG. 1e) aligns the exciting current better with the resonating current of the desired first order resonance mode, but may be insufficient in the sense of controlling the matching and the coupling. Voltage mode coupling creates roughly a suitable electric field for coupling the sufficient amount of energy in the basic mode into the filter, but it also easily excites other modes, because the direction and distribution of the exciting electric field cannot sufficiently be controlled.

### SUMMARY

An aspect is to provide a filter for electronic signals and a manufacturing method therefor which are cheap and result in improved harmonics suppression.

Another aspect is to provide a filter for electronic signals having an improved coupling structure.

A filter for electronic signals has a dielectric body, at least two coupling structures for coupling in and coupling out electronic signals, and one or more conductors on surface portions of the body. An outer surface of the body has one or more indentations. The indentations may have rounded surface portions and their contours may follow a hole in the body of the filter. They may be provided in a pairwise manner and may be symmetrical. They may have an internal symmetry, and two or more of them may be symmetrical with respect to each other. Particularly, two opposing surfaces may have indentations, preferably symmetrical to each other, whereas at least another pair of opposing surfaces does not have indentations (except the holes/throughholes/resonator holes) and are substantially flat.

The indentations maintain the effective diameter of the resonators above a certain value and, thus, have little effect on the Q-value and the performance, but help to suppress harmonics, because the cut-off frequency for non-desired modes is roughly doubled so that particularly second and third harmonics are better suppressed.

According to the filters described below, cavities of resonators formed by resonator holes are separated by reducing the width in between the cavities so that one nevertheless can maintain their diameter and the effective filter width can be reduced roughly to half or even less. “Cavity” in this sense is the space between the resonator hole conductor and the outer wall conductor. It is filled by the material of the filter body. This reducing roughly doubles the cut off frequency for the non-desired modes to around the fourth harmonic, so that the difficult second and third harmonics would be covered.

Further, a filter for electronic signals, which may optionally be formed as mentioned above, includes a dielectric body, one or more conductors on surface portions of the body, at least one resonator hole extending from a first surface of the body into the body, and a coupling structure for coupling in and/or out an electromagnetic signal. On the first surface of the body the coupling structure includes a conductor for signal input and/or output from/towards external, and in relation to an end portion of the conductor a coupling hole extending from the first surface and/or from an opposing second surface into the filter body.

The coupling hole may have or—together with other components—provide no or one or more predetermined resonance frequencies. It may have or provide insignificant resonance frequencies (i.e., sufficiently remote in frequency space from the desired frequency band, or non-existent). The coupling hole may be a through-hole or may be a blind hole extending from the first surface where the coupling conductor is provided or extending from the second surface opposing the first surface.

The location and dimension can be selected to optimize coupling, incoming impedance and excited resonance mode. The coupling hole may be provided asymmetrically in the cavity, whereas the resonator hole/s is/are in the centre of the cavity and of the filter body. The structure may be such that the coupling element is shorted at the same end as the resonator is and it is fed with a stripline at the other end of the resonator. i.e. it can be manufactured with the same steps as the actual resonator.

### BRIEF DESCRIPTION OF THE DRAWINGS

These and other aspects and advantages will become more apparent and more readily appreciated from the following description of the exemplary embodiments, taken in conjunction with the accompanying drawings of which:

FIGS. 1A and 1C to 1E are perspective views of known filters;

FIG. 1B is a vertical cross-section of the filter illustrated in FIG. 1A;

FIGS. 2A and 2B are perspective views of a first set of embodiments;

FIG. 2C is a cross-section of FIG. 2B;

FIG. 3 is a plan view of a second embodiment;

FIG. 4 is a plan view of a third embodiment; and

FIGS. 5A to 5C is a plan view of a fourth embodiment.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

Generally speaking, features described in this specification shall be deemed combinable with each other, even if this is not said explicitly, to the extent that a combination is technically possible. Same reference numerals shall denote same components.

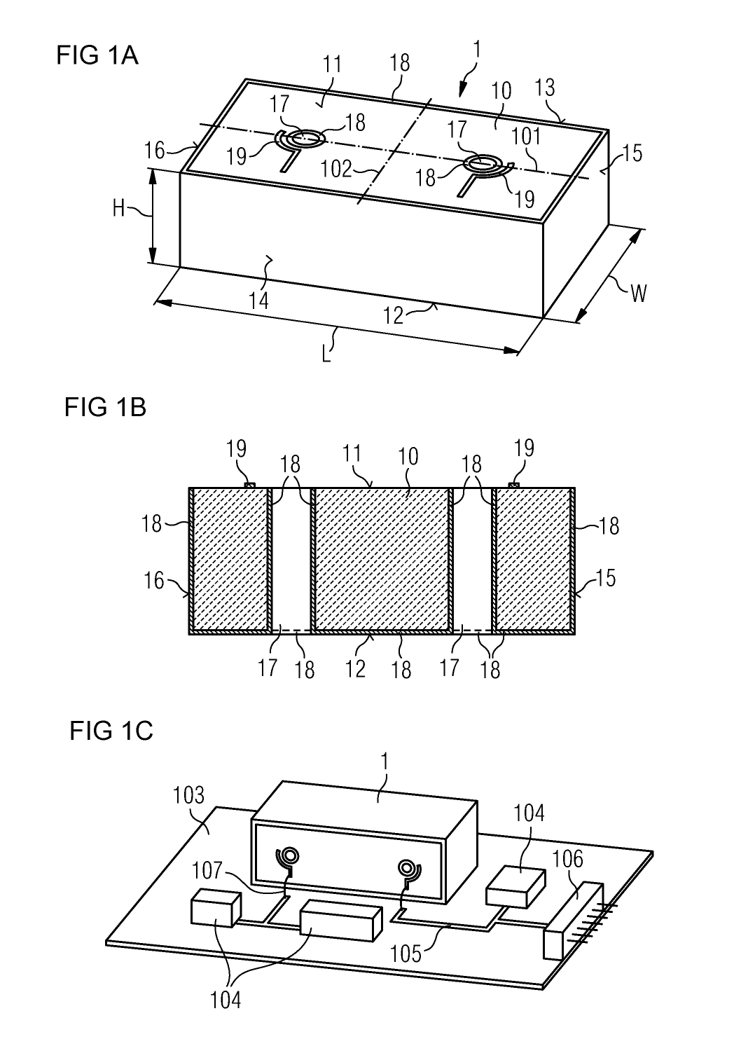

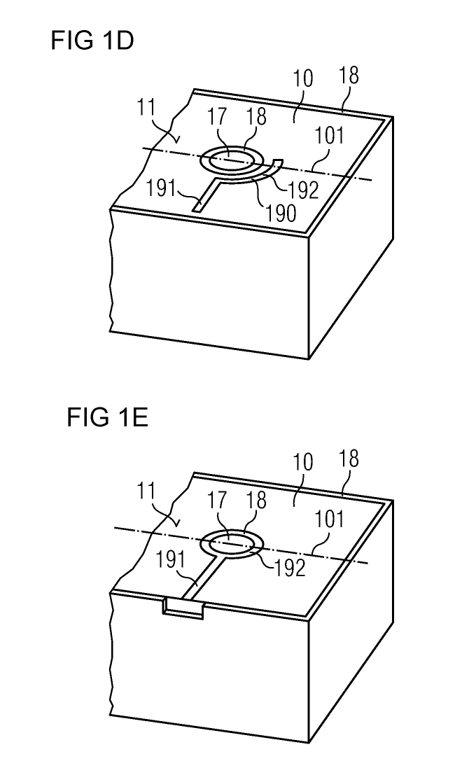

FIGS. 2A to 2C illustrate first embodiments showing an improved shape of a filter. The filter may be what is addressed as a ceramic monoblock filter. As far as not otherwise stated in the following, the filters may have features as described with reference to FIGS. 1A to 1E.

The body 10 of the filter 1 has a first surface 11 from which two holes 17, which may be resonator holes, extend into the body, preferably perpendicularly to the first surface 11, and preferably through the entire body down to the second (not visible) surface 12. A surface of the body 10, from which the holes do not extend, namely in FIG. 2A the fourth surface 14, has an indentation 20 reaching into the body, i.e., towards the third surface 13. Edges 20a, 20b and 20c defining or defined by this indentation may be in parallel to the axis of at least one of the holes 17.

The indentation 20 has an innermost point 21, i.e., a surface point most remote from surface 14 from which the indentation starts. The indentation may in itself be symmetrical in a sense that left and right surface portions thereof, i.e. portions left and right of the innermost point 21, are symmetrical to each other with respect to a plane symbolized by dashed line 22. The symmetry plane may be rectangular to the plane defined by the axes of the holes 17. The innermost portion may, in cross section, be the vertex of an angle, the angle preferably being smaller than 120° or smaller than 90°.

The indentation 20 may be positioned to indent at a space between two resonator holes 17 for reducing the width between resonators. More particularly, the indentation may have the same symmetry plane as two holes 17 left and right thereof in lengthwise direction. Generally speaking, the most indented portion 21 may project on a mid portion of a connecting line between adjacent holes 17. The mid portion may be the middle of the connecting line plus/minus 30% of the line length.

Indentations may be provided symmetrically with respect to a plane defined by axes through adjacent holes 17. This symmetry is shown in FIG. 2C where indentation 20a is symmetrical to indentation 20b with respect to a plane indicated by axis 101 in FIG. 1. Not only the indentations may have this symmetry with respect to plane 101, but also the remaining surface portions 13a, 13b, 14a, 14b.

Turning back to FIGS. 2A and 2B, the indentation restricts the body width between adjacent holes 17 and resonators built thereby while maintaining material thickness (“cavity” width) in a radial direction, seen from hole 17, above a given value. The material of the filter body 10 confined between the conductor on the inner wall of hole 17 and the conductor provided on the outer wall of the body may be considered like a cavity in a coax conductor. The indentations serve to maintain a certain minimum distance between inner conductor and outer conductor separated by the “cavity”, but restrict the material volume at the coupling of adjacent resonators. This is effective for suppressing certain modes and, particularly, for suppressing harmonics (second, third harmonics), without compromising other quality factors of the respective resonators and the overall filter.

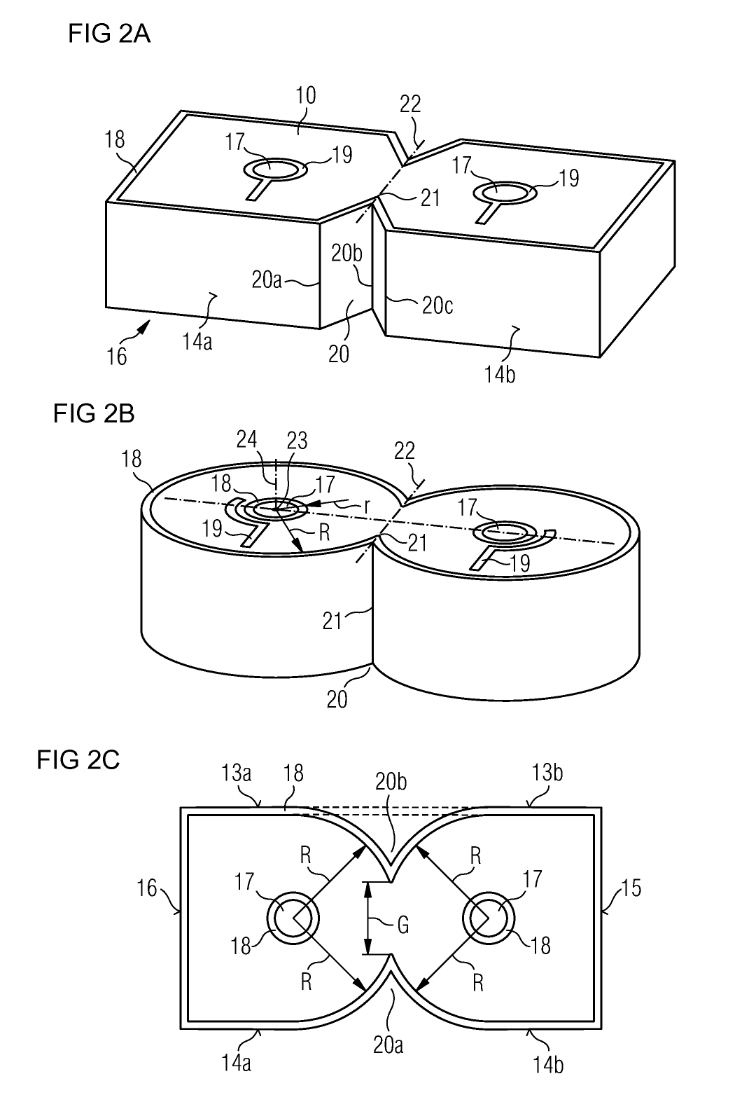

The dimensioning of the indentations 20 may optionally be such that the remaining body material between opposing indentations (20a and 20b in FIG. 3) or between an innermost portion 21 of an indentation 20 and the opposing wall is at least a certain percentage of the minimum material thickness between hole conductor and wall conductor, the percentage being 10% or 20% or 50% or 100%. Vice versa, an indentation or two opposing indentations together may take away at least 10% or at least 30% or at least 50% of the width of the body.

FIGS. 2A to 2C illustrate an embodiment where four of the six surfaces of the cuboid, namely surfaces 11, 12, 15 and 16 are more or less conventionally built, whereas the at least one surface 14, and possibly also the opposing surface 13, are provided with indentations. FIG. 2B shows an embodiment where the indentations follow a rounded contour which also effects surface 16 which remained conventional in the embodiment of FIG. 2A. As shown, the contour (rim) of the first surface 11 is rounded and has a discontinuity only where it meets the rounded contour around another hole 17.

The rounded contour may follow a circle or an ellipse. Likewise, the cross-section of the hole 17 may follow a circle or an ellipse. The mentioned circles or ellipses may be concentric. The rounded outer wall (corresponding to walls 13, 14, 15 and 16 in FIGS. 1A to 1E) may be completely covered by a conductor. The same applies to the (not shown/visible) bottom surface 12. Again conductors on the side walls, the bottom wall and the inner wall of holes 17 may be connected to each other and may, in use, be grounded.

In this specification, various shapes of indentations and holes are described. In a preferred embodiment, these shapes may be constant along the height direction of a filter. However, they may also be variable, and then the indications may apply to only a portion along the height of the filter or only to a cross-section at a particular height position.

FIG. 2C shows an embodiment that is a geometrical mix of the embodiments in FIGS. 2A and 2B. The indentations themselves have a cross-sectional contour following a circle of a radius R or an oval shape. However, once these rounded wall portions run into the respective straight walls, they continue as flat walls 13a, 13b, 14a, 14b until they reach the respective terminating wall 15, 16. The dashed line in the top part of FIG. 2C indicates the case that an indentation is provided only at wall 14, wall 13 remaining conventional, as indicated by the dashed lines.

The dimension G indicates the remaining width between an indentation 20a and the opposing surface which may again be an indentation or, if no indentation is provided, the opposing wall as indicated by the dashed lines in FIG. 2C. It may be sized as mentioned above.

FIG. 3 shows an embodiment with five holes 17 in a row, aligned along a straight axis/plane 101. The axes of holes 17 may be parallel to each other. Holes 17 may all be coated by conductors 18. The outer wall may also be completely coated, just like the bottom wall opposing wall 11. Generally speaking, a filter may have a succession of two, three, four, five, six, seven or more resonators formed by a hole with conducting walls and a surrounding surface on the body 10 of the filter 1. The respective rounded portions (hole, wall portions) may follow circles which may be concentric. The involved radii of holes and outer wall portions may be same or different. Similarly, the distance between adjacent resonator holes 17 may be constant or different from each other.

The overall size of the filter may be set in relation to the desired operating frequency range of the filter. The operating frequency range may be a frequency or frequency range between 200 MHz and 10 GHz. It may be for mobile communication applications, particularly for base stations and stationary equipment thereof, and may be suitable for one or more of the frequency ranges required there.

The manufacturing method may be as follows:

First, a powder of the desired material is prepared. The powder may have an average grain size as desired. The material is selected also in view of its dielectric constant.

Thereafter, the powder is pressed into the desired shape of the filter body 10. This pressing may include the provision of holes 17 by having respective rods in the mold for pressing the powder. The mold for pressing the powder may already have the indentations 20. Likewise, however, at this stage, the walls may still be conventional, i.e. as shown in FIG. 1.

Next, the pressed body is fired, i.e. heated up to a certain temperature and kept at a certain temperature profile over time. Time may be several hours (two or more hours), temperatures may exceed 1000° C. or 1200° C. Through this, the powder particles bake together as in sintering and become a solid body of high mechanical strength.

If not already provided in the pressed form, the so fired body would now be provided with the indentations 20, preferably after having cooled down. This may be done by mechanical treatment like grinding or using a diamond tool. A profiled wheel for grinding may be used. The mechanical treatment, however, may also be made when the fired body has already indentations. The mechanical treatment may then be for refining surfaces or bringing the wall geometry down to a finally defined shape.

Once the final geometry of the body, including the desired indentations 20 and holes 17, is reached, it will be covered with conductors, which may be metallizations in certain embodiments. This may be done by immersing the body into a silver paint bath and drying it. This may be done repeatedly.

For improving the conductivity the so obtained silver coating may again be fired for achieving the desired better conductivity of the conductors covering substantial parts of most of the surfaces. The surfaces (except one) may be covered by at least 50% or at least 70% thereof by conductors, these conductors are preferably interconnected and may be grounded in use. Metallization coverage may also be 100%. This also applies to the inner walls of the holes 17.

This covering process may also include the first (top) surface which, thereafter, would be structured as desired. Particularly, metallization must be removed by an appropriate process (e.g. etching), so that only the desired pattern remains. Particularly, the coupling conductors 19 must be formed. Further, as far as present, the connection to the wall metallizations must be interrupted. Bringing the desired structures onto the first surface may also be done by an appropriate printing technique, such as the silk screen method.

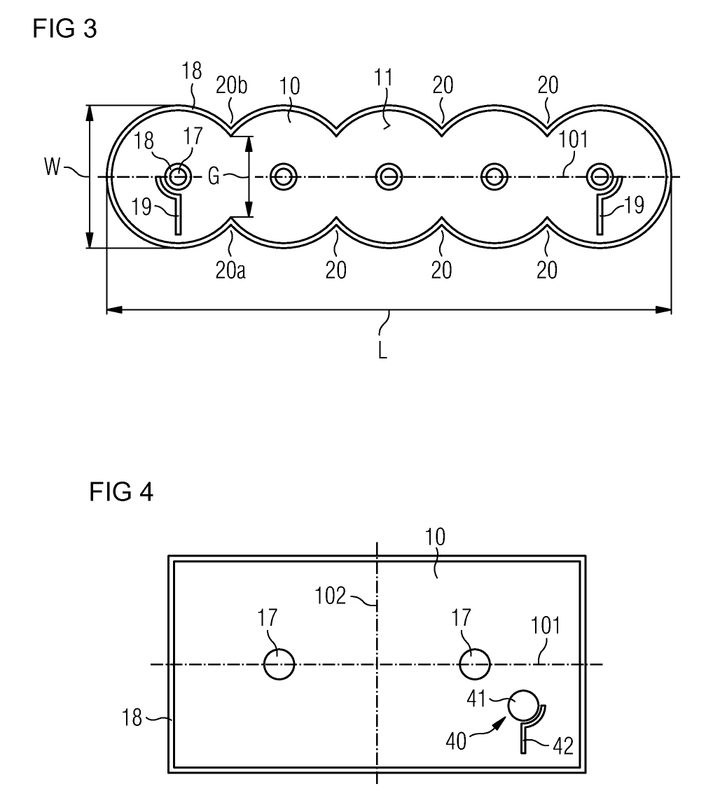

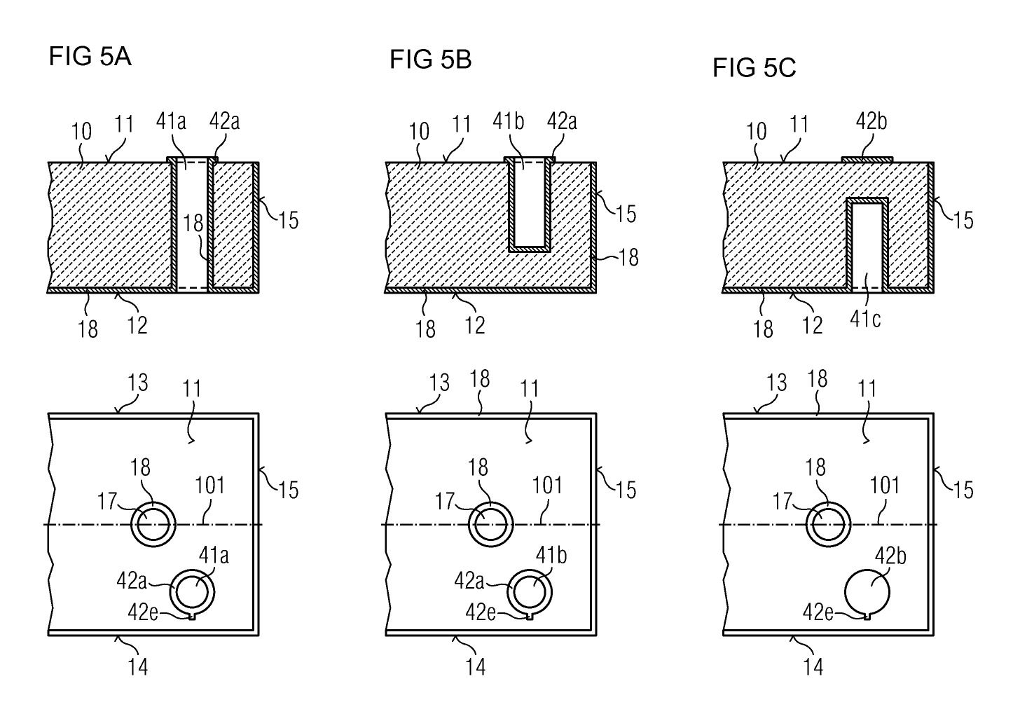

FIGS. 4 and 5 show improved couplings for filters. A coupling structure 40 is shown in the lower right corner of the filter body 10 in FIG. 4. A conductor 18 covering the walls as described above is only partially shown there, although it is present as shown in, and described with respect to FIGS. 1 to 3. The coupling 40 has a coupling hole 41 and a coupling conductor 42. The coupling conductor 42 is provided on the first surface 11. It runs from a rim of the first surface towards the coupling hole 41. Coupling hole 41 may be provided asymmetrically with respect to symmetry lines given by the shape of the filter body 10. Particularly, it may be away from horizontal or vertical symmetry lines 101, 102.

The coupling hole 41 may practically be non-resonant, or it may have a resonance frequency remote from the working frequency range of the filter, e.g. more than 2% or more than 5% of the nominal frequency away therefrom. The coupling impedance is tuned to the desired value at the operating frequency. The coupling conductor 42 serves to make electrical contact between outside circuitry to which it is connectable via its rim side end 42e. From there, it runs towards the coupling hole 41 and, there, may make voltage mode coupling as schematically indicated in FIG. 4 and also FIG. 1B, or may make current mode coupling as shown in FIGS. 5A and 5B and also FIG. 1E.

Coupling hole 41 may be a through-hole as shown in FIG. 5A or may be a blind hole as shown in FIGS. 5B and 5C. In the one case, it may extend from the first surface into the depth of the body 10, particularly with rounded or circular cross-section, preferably constant over at least a part of or all of the depth (FIG. 5B). In the other case, the blind hole 41c may extend from another surface, e.g., the second surface 12 opposing the first surface 11 into the body, again preferably with rounded or circular contour which is preferably constant over at least a part or all of the depth of the hole. Coupling hole 41 is also provided with a conducting layer, such as a metallization. The conductor may be connected to conductor 18 covering the other walls of the filter body 10 (FIGS. 5A and 5c).

In FIG. 5B, the conductor covering the coupling hole surface may be isolated from conductor 18. The positioning, shaping and contacting of the coupling hole 41 may be done in view of coupling performance. Particularly, coupling efficiency and impedance matching aspects may be considered for selecting the make (FIG. 5A or 5B or 5C) and the positioning of the coupling hole 41 and the design of the coupling conductor 42. FIG. 5A is a current mode coupling, because the coupling conductor 42a is in contact with the conductor 18 of coupling hole 41a. FIG. 5B is a mixed mode variant of FIG. 5A. Here, the coupling conductor 42a contacts the conductor/metallization of coupling hole 41b which, however, is isolated from the covering conductor 18. FIG. 5C is called “loaded electrical coupling”. It is similar to voltage mode coupling, because the coupling conductor 42b is not in contact with the conductor covering the walls of coupling hole 41c.

Generally speaking, either voltage mode coupling or current mode coupling is combinable with any of the makes of coupling holes 41a or 41b as shown in FIGS. 5a and 5b.

The coupling holes 41 can substantially be manufactured just as the resonator holes 17. Also providing their respective conductor on their surfaces can be made in the same way. Some extra steps need to be taken for FIG. 5B when immersion into silver paint is used, because this may not cover the first surface 11 and, thus, also not the surface of coupling hole 41b.

In the described filters, the coupling structure described with reference to FIGS. 4 and 5A to 5C is combinable with the indentation technology described with reference to FIGS. 2A to 2C and 3. However, these aspects may also be separate from each other.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1. A filter for electronic signals comprising:
a dielectric body having an outer surface with at least one indentation; and
at least two coupling structures coupling in and coupling out electronic signals, and one or more conductors on surface portions of the dielectric body.

2. A filter according to claim 1,
wherein the dielectric body comprises at least two holes, extending from a first surface of the dielectric body into the dielectric body, which are through-holes of at least partially constant cross-sectional contour, and
wherein at least one indentation is formed on the dielectric body surface such that its most indented portion projects on a mid portion of a connecting line between two adjacent holes, the mid portion being the mid point of the line ±30% of the line length.

3. A filter according to claim 2, wherein surface portions of an indentation are formed to substantially follow the surface portion of a hole, equidistant, wherein both the hole and the surface have a contour following concentric circles.

4. A filter according to claim 3, wherein two indentations are formed symmetrically to each other with respect to a symmetry axis, defined by two holes extending from a first surface of the dielectric body into the dielectric body.

5. A filter according to claim 4, wherein the dielectric body comprises two pairs of opposing surfaces, the surfaces of one pair having the indentations, the surfaces of the other pair being flat.

6. A filter according to claim 5, further comprising at least two holes arranged along a straight line and extending from a first surface of the dielectric body into the dielectric body, at least one being through-holes, wherein the holes have in a cross sectional plane parallel to the first surface a circular cross sectional contour, and the indentations have surface portions equidistantly following the cross sectional contour of the holes.

7. A filter according to claim 6, wherein at least one of
the indentations are formed by machining a sintered body and/or by appropriately shaping a body to be sintered,
the conductors are formed by metallizing the sintered body,
at least one resonating hole is a through-hole of constant cross-section over at least a part of the hole depth,
an indentation has an at least partial symmetrical cross section,
the filter is for a frequency above 200 MHz,
the filter is for a frequency above 450 MHz,
the length of the body is larger than 30 mm or larger than 50 mm or smaller than 100 mm or smaller than 80 mm, the width of the body is larger than 6 mm or larger than 9 mm or smaller than 25 mm or smaller than 15 mm and may be 1 to 4 times the height of the body, the height of the body is larger than 3 mm or larger than 5 mm or smaller than 120 mm or smaller than 9 mm,

8. A filter for electronic signals, comprising:
a dielectric body;
one or more conductors on surface portions of the dielectric body;
at least one resonator hole extending from a first surface of the dielectric body into the dielectric body, which is a through-hole of at least partially constant cross-sectional contour in the depth direction; and
a coupling structure, coupling in and/or out an electromagnetic signal, including on a first surface of the dielectric body a coupling conductor for at least one of signal input and signal output, and in relation to an end portion of the conductor a coupling hole extending from the first surface and/or from a second surface opposite the first surface into the dielectric body.

9. A filter according to claim 8, wherein the coupling hole is provided asymmetrically with respect to at least two resonator holes and/or with respect to the contour of the first surface.

10. A filter according to claim 9, wherein the coupling hole is one of a through hole and a blind hole extending from the first surface and the end portion of the coupling conductor approaches the rim of the coupling hole.

11. A filter according to claim 9, wherein the coupling hole is a blind hole extending from the second surface and the end portion of the conductor approaches an area on the first surface above the coupling hole.

12. A filter according to claim 11, wherein a resonance frequency of the coupling hole is remote from the desired working frequency of the filter.

13. A filter according to claim 12, wherein at least one of
the filter is a ceramic monoblock filter,
the dielectric body is a sintered body,
the filter is for a frequency above 1700 MHz,
the filter is for a frequency above 2000 MHz,
the filter is for a frequency below 3000 MHz,
the filter is for a frequency below 2300 MHz,
all surfaces of the dielectric body including hole surfaces. except a first surface of the dielectric body, have interconnected conductors covering at least 80% of the respective surface.

14. A method for forming a filter for electronic signals, the filter having a dielectric body, at least two coupling structures for coupling in and coupling out electronic signals, and one or more conductors on surface portions of the dielectric body, the method comprising:
forming the dielectric body with at least one indentations on at least one surface thereof; and
providing required conductors and coupling structures.

15. A method according to claim 14,
wherein said forming of the dielectric body includes pressing a powder into a dielectric body of a desired contour and sintering the dielectric body, and
wherein the indentations are formed by appropriately shaping the dielectric body to be heated and/or by machining the dielectric body that has been heated.

16. A method according to claim 15, wherein the holes are formed in said pressing of the powder by a correspondingly shaped rod in a pressing mold.
